(19) United States
(12) Patent Application Publication
(10) Pub. No.: US 2025/0251229 A1
(43) Pub. Date: Aug. 7, 2025

(54) MEASUREMENT PROBE HEAD IDENTIFICATION

(71) Applicant: Hexagon Metrology, Inc., North Kingstown, RI (US)

(72) Inventors: Ingo Lindner, Wetzlar (DE); Milan Kocic, Pawtucket, RI (US)

(21) Appl. No.: 19/039,175

(22) Filed: Jan. 28, 2025

Related U.S. Application Data
(60) Provisional application No. 63/550,497, filed on Feb. 6, 2024.

(51) Int. Cl. G01B 5/012

(52) U.S. Cl. CPC G01B 5/012

(57) ABSTRACT

A measurement probe identification system for a coordinate measurement machine may include a measurement probe configured to measure a workpiece on a coordinate measurement machine, the measurement probe being one of a tactile measurement probe, a non-contact light based probe, and a camera probe and a magnetic sensor associated with the measurement probe. The measurement probe has a unique identification and the magnetic sensor is configured to emit a magnetic signal in response to receipt of a magnetic field. The magnetic signal is associated with a unique identification of the measurement probe based on a magnetic signature and the magnetic signature is readable to determine the unique identification.

### PRIORITY

This patent application claims priority from Provisional U.S. Patent Application No. 63/550,497, filed Feb. 6, 2024, entitled MEASUREMENT PROBE HEAD IDENTIFICATION and naming Ingo Lindner, Milan Kocic, and Damien Carron as the inventors, the disclosure of which is incorporated herein in its entirety, by reference.

### FIELD

Illustrative embodiments of the invention generally relate to coordinate measuring machines (CMMs) and, more particularly, various embodiments of the invention relate to a wireless CMM probe/stylus identification system.

### BACKGROUND

Coordinate measuring machines (“CMMs”, also known as surface scanning measuring machines) measure geometry and surface profiles or verify the topography of known surfaces. For example, a CMM may measure the topological profile of a propeller to ensure that its surface is appropriately sized and shaped for its specified task (e.g., moving a 24 foot boat at pre-specified speeds through salt water). To that end, conventional CMMs often have a base supporting a workpiece to be measured. The base is directly connected with and supporting a movable assembly having a probe that directly contacts and moves along a surface of a workpiece being measured. CMMs represent a gold standard for accurately measuring a wide variety of different types of workpieces. For example, CMMs can measure critical dimensions of aircraft engine components, surgical tools, and machine parts. Precise and accurate measurements help ensure that their underlying systems, such as an aircraft in the case of aircraft components, operate as specified. Some workpieces are measured to a fine precision, such as on the micron level. The accuracy of a CMM may depend, in part, on the measuring device (e.g., probe/stylus) used for the measurement, where many such probes and stylii may be available.

### SUMMARY OF VARIOUS EMBODIMENTS

In accordance with one embodiment of the invention, a measurement probe identification system for a coordinate measurement machine may include a measurement probe configured to measure a workpiece on a coordinate measurement machine, the measurement probe being one of a tactile measurement probe, a non-contact light based probe, and a camera probe and a magnetic sensor associated with the measurement probe. The measurement probe has a unique identification and the magnetic sensor is configured to emit a magnetic signal in response to receipt of a magnetic field. The magnetic signal is associated with a unique identification of the measurement probe based on a magnetic signature and the magnetic signature is readable to determine the unique identification.

In accordance with other embodiments, where the measurement probe identification system also includes a reader that receives the magnetic signal and converts the magnetic signal into the magnetic signature. The reader is configured to determine the unique identification of the measurement probe as a function of the magnetic signature.

In accordance with other embodiments, the reader may include a coil to detect the magnetic signature.

In accordance with other embodiments, the reader is configured to determine the unique identification in response to the magnetic sensor being proximate to the coil.

In accordance with other embodiments, the reader may include a passive portion configured to receive the magnetic signal and an active portion configured to emit the magnetic field toward the magnetic sensor.

In accordance with other embodiments, the active portion uses magnetic induction to produce the magnetic signal received by the passive portion.

In accordance with other embodiments, the measurement probe identification system may include a probe rack, configured to temporarily store one or more different measurement probes in rack ports, where the probe rack includes the reader.

In accordance with other embodiments, the measurement probe identification system may include a memory device, configured to store unique identifications for measurement probes stored in rack ports.

In accordance with other embodiments, the measurement probe identification system may include a processor, coupled to the memory device, configured to update the unique identifications in the memory device in response to measurement probes added to or removed from the rack ports.

In accordance with another embodiment of the invention, a method of selecting a measurement probe of a coordinate measurement machine may include providing a measurement probe configured to be used with a coordinate measurement machine, emitting a magnetic field toward the measurement probe to cause the magnetic sensor to produce a magnetic signal in response to receipt of the magnetic field, converting the magnetic signal into a magnetic signature, and determining, by a reader, the unique identification of the measurement probe as a function of the magnetic signature. The measurement probe has an associated magnetic sensor and the magnetic sensor has an associated unique identification.

In accordance with another embodiment of the invention, a computer program product for use on a computer system for selecting a measurement probe of a coordinate measurement machine may include a tangible, non-transient computer usable medium having computer readable program code thereon. The computer readable program code may include program code for directing emission of a magnetic field toward the measurement probe to cause the measurement probe to produce a magnetic signal, controlling a reader to read the magnetic signal and convert the magnetic signal into a magnetic signature, determining a unique identification of a measurement probe as a function of the magnetic signature, and selecting the measurement probe as a function of the determined unique identification.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1A schematically shows a diagram illustrating a representative coordinate measurement machine (CMM) in accordance with illustrative embodiments.

FIG. 1B schematically shows an interface panel that may be used with the coordinate measuring machine in accordance with illustrative embodiments.

FIG. 2 schematically shows a probe rack diagram in accordance with illustrative embodiments.

FIG. 3 schematically shows a detachable probe in accordance with illustrative embodiments.

FIG. 4 schematically shows a stylus rack in accordance with illustrative embodiments.

FIG. 5 schematically shows a stylus in accordance with illustrative embodiments.

FIG. 6 schematically shows a CMM measurement process in accordance with illustrative embodiments.

FIG. 7 schematically shows a sensor in accordance with illustrative embodiments.

FIG. 8 shows an exemplary probe identification system based on probe rack ports in accordance with illustrative embodiments.

FIG. 9 shows a probe identification table in accordance with illustrative embodiments.

FIG. 10 shows a probe exchange process in accordance with illustrative embodiments.

### DESCRIPTION OF ILLUSTRATIVE EMBODIMENTS

In illustrative embodiments, a coordinate measuring machine (CMM) may utilize a number of different probes of different types for various measurement tasks involving varied workpieces. The probes may be stored in a probe rack, which provides a set of probe ports to store each probe. Preferably, each probe may be stored in a random probe port and the system may determine an identity of each probe in a probe port using a contactless sensor affixed to each probe. In response to a received exchange request, the system may determine an empty probe port where a returned probe should be stored and may identity a probe port where a requested probe is currently stored. To those ends, each probe has an associated sensor that uniquely identifies that probe. Details are discussed below.

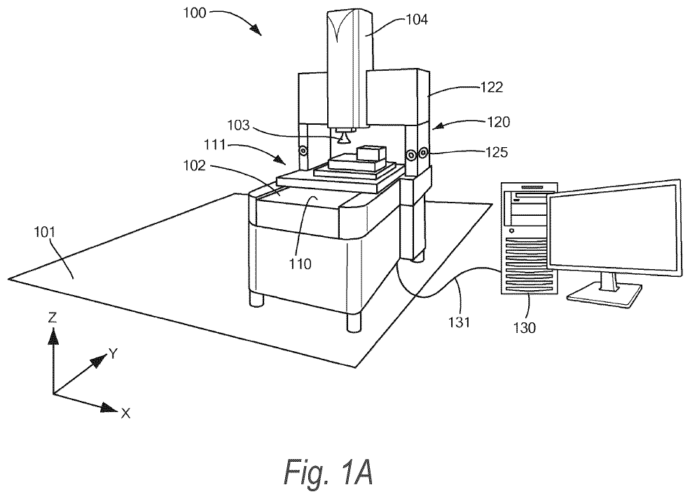

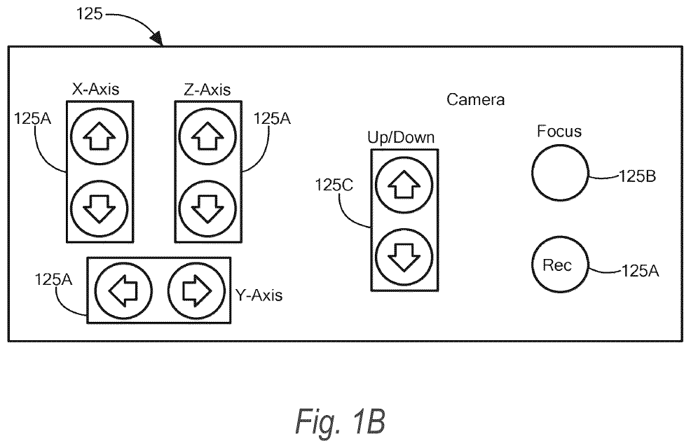

FIG. 1A schematically shows a representative coordinate measurement machine (CMM) 100 in accordance with illustrative embodiments. As known by those of skill in the art, the CMM 100, which is supported on a floor 101 in this illustration, measures a workpiece 111 on its bed/table/base (referred to as “base 102”). Generally, the base 102 of the CMM 100 defines an X-Y plane 110 parallel to the plane of the floor 101.

To measure a workpiece 111 on its base 102, the CMM 100 has movable features 122 arranged to move a measuring device 103, such as a mechanical, tactile probe (e.g., a touch trigger or a scanning probe in a standard CMM), a non-contact probe (e.g., using laser probes), and/or a camera (e.g., a machine-vision CMM), coupled with a movable arm 104.

Alternately, some embodiments move the base 102 with respect to a stationary measuring device 103. Either way, the movable features 122 of the CMM 100 manipulate the relative positions of the measuring device 103 and the workpiece 111 (or calibration artifact) with respect to one another to obtain the desired measurement. Accordingly, the CMM 100 can measure locations of a variety of features of the workpiece or artifact 111. The CMM 100 has a motion and data control system 120 that controls and coordinates its movements and activities.

Among other things, the control system 120 may include a computing device 130 and the noted sensors/movable features 122. The computing device 130 may include a microprocessor, programmable logic, firmware, advance control, acquisition algorithms, and analysis algorithms. The computing device 130 may have on-board digital memory (e.g., RAM or ROM) for storing data and/or computer code, including instructions for implementing some or all the control system operations and methods. Alternately, or in addition, the computing device 130 may be operably coupled to other digital memory, such as RAM or ROM, or a programmable memory circuit for storing such computer code and/or control data.

Among other things, the computing device 130 may be a desktop computer, a tower computer, or a laptop computer, a tablet computer or a pad computing device, a smart phone, a smart watch, or any other form a wearable computer. The computing device 130 may be coupled to the CMM 100 via a hardwired connection, such as an Ethernet cable 131, or via a wireless link, such as a Bluetooth or a WiFi link. The computing device 130 may, for example, include software to control the CMM 100 during use or calibration, and/or may include software configured to process data acquired during a calibration process (e.g., Hexagon PC-DMIS Pro, PC-DMIS CAD, or PC-DMIS CAD++). In addition, the computing device 130 may include a user interface configured to allow a user to manually operate the CMM 100.

Because their relative positions are determined by the action of the movable features 122, the CMM 100 may be considered as having “knowledge” about data relating to the relative locations of the base 102, and the workpiece or artifact 111, with respect to its measuring device 103. More particularly, the computing device 130 controls and stores information about the motions of the movable features 122. Alternately, or in addition, the movable features 122 of some embodiments may include sensors that sense the locations of the table and/or measuring device 103, and probes, and report that data to the computing device 130. The information about the motions and positions of the table and/or measuring device 103 of the CMM 100 may be recorded in terms of a two-dimensional (e.g., X-Y; X-Z; Y-Z) or three-dimensional (X-Y-Z) coordinate system referenced to a point on the CMM 100. The CMM 100 may also include a user interface 125 that may allow a user to start operation, stop operation, make adjustments, and the like.

FIG. 1B schematically shows a user interface panel that may be used with the coordinate measuring machine, in accordance with illustrative embodiments. As shown, the user interface 125 may have control buttons 125A and knobs 125B that allow a user to manually operate the CMM 100.

Among other things, the user interface 125 may enable the user to change the position of the measuring device 103 or base 102 (e.g., with respect to one another) and to record data describing the position of the measuring device 103 or base 102.

In addition, the user interface 125 may enable the user to focus a camera (if the measuring device 103/arm 104 includes a camera) on a workpiece or target 111 and record data describing the focus of the camera. In a moving table CMM, for example, the measuring device 103 may also be movable via control buttons 125C. As such, the movable features 122 may respond to manual control, or under control of the computing device 130, to move the base 102 and/or the measuring device 103 (e.g., a mechanical probe in a mechanical CMM or a camera in a machine vision CMM 100) relative to one another. Accordingly, this arrangement permits the workpiece 111 being measured to be presented to the measuring device 103 from a variety of angles, and in a variety of positions and orientations.

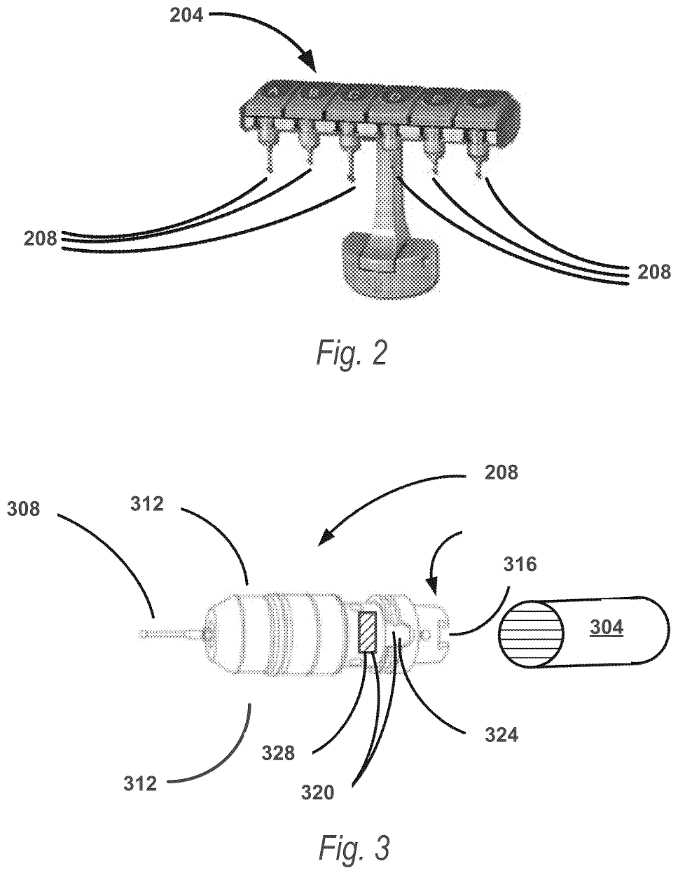

FIG. 2 schematically shows a probe rack 204 in accordance with illustrative embodiments. As shown, the probe rack 204 may store one or more different probes 208 with stylii in general proximity to the CMM 100. That rack may be coupled directly to the CMM 100 or be separate from the CMM 100. Different probes 208 may have different stylus sizes installed or be different types of probes 208. In one embodiment, one or more probes 208 may include multiple stylii. The multiple stylii may have different lengths or physical dimensions or be different types of stylii (e.g., tactile, optical, camera, etc.). The probe rack 204 may provide a uniform way to store the probes 208 in an organized and centralized fashion. Each probe 208 may have its own probe port, and in one embodiment, the probe ports may be equally spaced within the probe rack 204. Each of the probes 208 may be selectively and individually coupled with the movable arm 104 of the CMM 100. As noted above, the probes 208 may be any one of a variety of types of probes 208, such as a mechanical, tactile, or non-contact probe such as an optical probe or camera, to name but a few examples. In operation, any of the probes 208 may be changed, removed from and/or coupled to the movable arm 104 of the CMM 100, either manually by an operator, or robotically by the CMM 100. For example, a probe 208 may be removed from a probe port and coupled to a probe interface 304, as shown in FIG. 3. In one embodiment, probe 208 selection may depend on a workpiece to be measured 111.

FIG. 3 schematically shows a detachable probe 208 in accordance with illustrative embodiments. Some probes 208 may be configured to operate with a specific type of stylus 308. For example, some probes 208 may have an interface 304 that includes one or more sensors 312 to detect deflection of a tactile stylus 308 when that stylus 308 contacts a workpiece 111. Other probes 208 may have an interface 304 (which may be referred to as a “stylus interface”) that includes electronics to receive electrical signals, such as from an optical stylus or multiple stylii, for example. In one embodiment, the probe 208 may twist onto a distal end of the probe interface 304 and may include one or more retention features.

Probes 208 may also include a probe body 312 with a physical interface 316 (to mount to the CMM 100) having a probe indicium 320 to identify a probe physical feature. They indicium 320 may be in the form of the physical feature that uniquely identifies the probe 208, or its type. The corresponding probe interface 304 on the CMM 100, alone or in concert with the computing device 130, may confirm the identity of the probe 208 by sensing the physical feature through the physical interface 316.

In another embodiment, the body 312 of the probe 208 may have a surface feature 324 that uniquely identifies the probe 208, or its type, and which may be detected by the CMM 100, for example, by using a camera. Among other things, the surface feature 324 may include raised text, a color, or recesses in a specified pattern. In another embodiment, the body 312 of the probe 208 may include an identity interface 328 that uniquely identifies the probe 208, or its type. For example, the identity interface 328 may be an optically readable feature such as a bar code, a color, or another optical indicia that may be read by the camera. In other embodiments, the physical interface 316 may be an electrical interface configured to make electrical contact with the CMM 100 and generate an electrical signal with a pattern or signature that uniquely identifies the probe 208. For example, this interface 316 may be a part of the probe interface 304 that couples with the CMM arm 104. In other embodiments, the physical interface 316 may include a transmitter, such as an RFID chip, that transmits an identifier that uniquely identifies the probe 208, for example in response to a query from the CMM 100. In one embodiment, each probe 208 may include a contactless sensor (not shown) within the probe body 312.

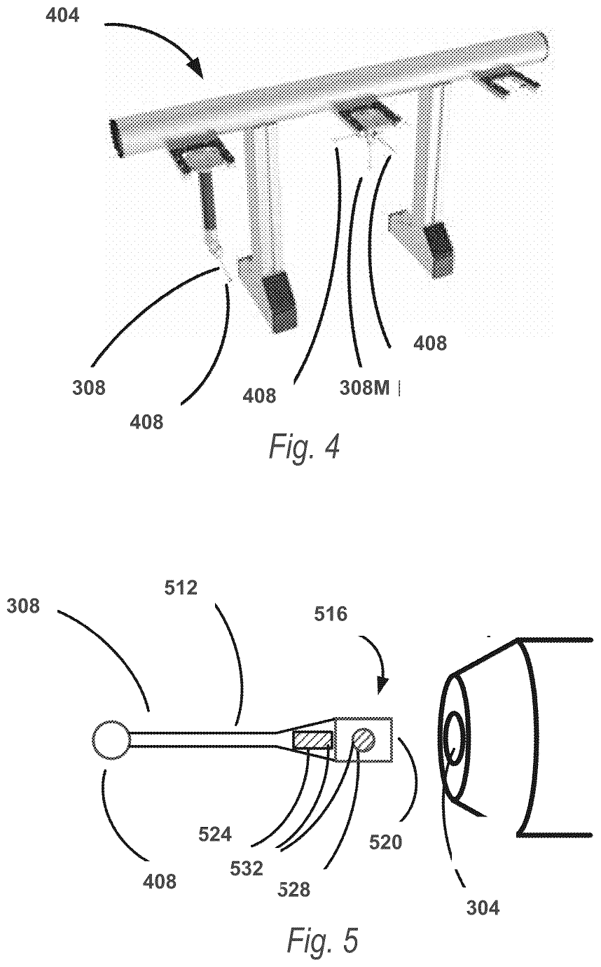

FIG. 4 schematically shows a stylus rack 404 in accordance with illustrative embodiments. Each stylus 308 in the stylus rack 404 may be coupled with a probe 208, and thereby coupled to the movable arm 104 of the CMM 100, and accordingly functions as the above-noted measuring device. Moreover, each stylus 308 may be any one of a variety of types of stylus 308, such as a single-headed stylus 308 having a single stylus tip 408 (e.g., FIG. 5), or a multi-headed-stylus 308M having more than one stylus tip 408, and may be a tactile stylus (e.g., a stylus that measures a workpiece 111 by contacting the workpiece 111), or a non-contact stylus (e.g., an optical stylus 308 that measures a workpiece 111 without contacting the workpiece 111), to name but a few examples. In operation, a stylus 308/308M may be changed, removed from, and/or coupled to a probe 208, either manually by an operator, or automatically (robotically) by the CMM 100. For example, the stylus 308/308M may be removably coupled to the probe body 312.

FIG. 5 schematically shows another stylus 308 in accordance with illustrative embodiments. As known by those in the art, the stylus 308 includes a body 512 and a stylus tip 408. The stylus 308 mounts to the probe 208 via the probe interface 304 using a physical interface 516. The physical interface 516 may include a physical feature 520 that uniquely identifies the stylus 308. A corresponding stylus interface on the probe 304, alone or in concert with the computing device 130, may confirm an identity of the stylus 308 by sensing the physical feature 520. In one embodiment, a stylus 308 may include a contactless sensor 524. In one embodiment, a stylus 308 may also include one or more forms of indicia 528, 532 other than or in addition to a contactless sensor 524.

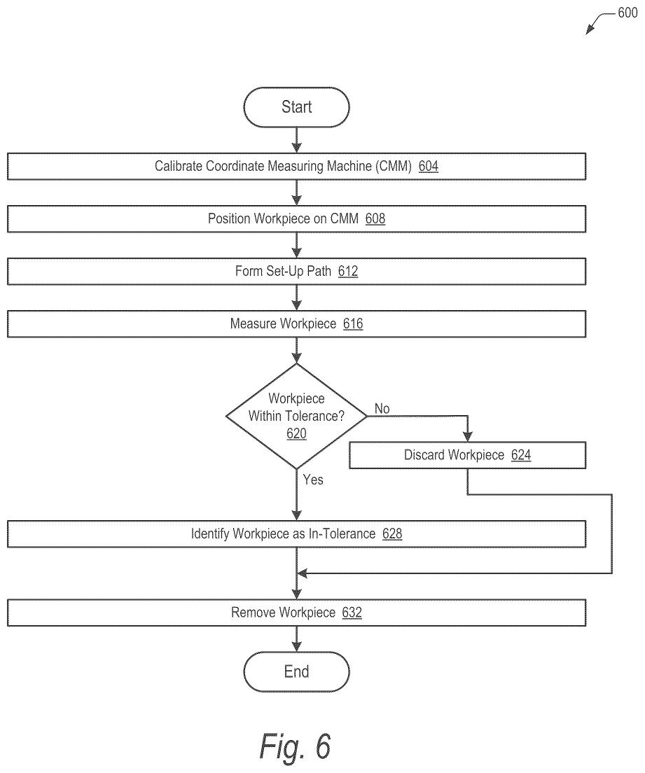

FIG. 6 schematically shows a CMM Measurement Process 600 with a tactile stylus 308. Some of the steps shown in FIG. 6 may be performed in a different order than that shown or at the same time. Those skilled in the art therefore can modify the process as appropriate. It also should be noted that reference to an operator performing certain steps is but one of a number of different options. Some embodiments may use a logic device or automated robot to perform some of the steps. Accordingly, discussion of an operator is not intended to limit various embodiments. This process preferably is repeated many times for a plurality of different workpieces 111 manufactured to a same specification. For example, this process may be used to measure hundreds of jet engine blades that nominally are identically manufactured.

The process of FIG. 6 begins at step 604, in which an operator calibrates the CMM 100. More particularly, to accurately measure the workpiece 111, the CMM 100 should have data relating to the actual orientation and position of an optional rotary table (or on the base without a rotary table) on the CMM 100 relative to the other components of the CMM 100. As such, the system may gather data relating to a vector and a position of the axis about which the rotary table rotates. To that end, an operator first may position a substantially straight shaft at the nominal center of the rotary table. Next, the operator may rotate the shaft in pre-specified increments, such as 90 degree increments, and measure the orientation and location of the shaft at each increment. Using well-known CMM calibration routines, this process should enable the CMM 100 to gather data about the actual orientation and location of the rotary table. In other words, this initial calibration process provides the frame of reference of the rotary table to the system. Flow proceeds to block 608.

At block 608, after calibrating the CMM 100, the operator positions the workpiece 111 on the rotary table of the CMM 100. At this stage of the process, this workpiece 111 just positioned on the rotary table may be the first of a series of nominally identical workpieces 111 to be measured by the CMM 100. Of course, some embodiments may measure just one workpiece 111, or multiple workpieces 111. Flow proceeds to block 612.

At block 612, a set-up or initial path is formed for performing a first scan of the workpiece 111 on the rotary table. More specifically, as known by those skilled in the art, the workpiece 111 preferably was manufactured based on a set of nominal requirements/specifications identifying its ideal structure. For example, the set of nominal requirements may include geometry information, such as the flatness or waviness of the surface, the size of the workpiece 111, the size and shape of certain features of the workpiece 111, the distances between certain features of the workpiece 111, the orientation of certain features relative to other features of the workpiece 111, etc. This set of nominal specifications and/or geometry may be typically stored in a computer-aided design file (a “CAD” file) in a memory device of the CMM 100 (e.g., in memory in the computing device 130). A jet engine blade is a good example of a workpiece 111 that may benefit from illustrative embodiments. As known by those in the art, a jet engine blade has two large, opposed surfaces, and two very thin edges between the two large, opposed surfaces. As also known by those skilled in the art, the two opposed surfaces often have complex contours and geometries that, despite state-of-the-art manufacturing techniques, often widely vary from the nominal requirements. Such workpieces 111 therefore often have relatively large deviations from the nominal.

In one embodiment, the computing device 130 may form the set-up path by using nominal model data present in a computer-aided design (CAD) file, as well as calibration information identifying the position of the rotary table and other parts of the CMM 100.

Because it is based upon nominal information, the set-up path likely may periodically move the workpiece 111 in and out of a focal plane of an optical probe or camera (i.e., beyond the focal length) of the probe 208 during probe travel. Despite that, the set-up path should be accurate enough for the probe 208 to have a first accuracy that is sufficient for its intended function. In other words, although this first accuracy may not be sufficient to appropriately measure the workpiece 111, it should be sufficient to gather data to ultimately form the actual scan path that will be used to measure the workpiece 111. Flow proceeds to block 616.

At block 616, after generating the scan path, the CMM 100 measures the workpiece 111. To that end, the computing device 130 directs the probe 208 along the calculated scan path(s) to determine the actual measurements of prescribed portions of the workpiece 111. Regardless of whether the workpiece 111 has a discontinuity or not, the CMM 100 may measure some or all of each scan path. In some embodiments, the CMM 100 may measure a same or different part of the workpiece 111 with different stylii of a multi-stylus probe 208. This measurement has a second accuracy that preferably is better than the accuracy of the first scan. Flow proceeds to decision block 620.

It should be noted that some embodiments skip this two-pass method to form the scan path. In that case, the measurement platform may use CAD data of the workpiece 111 and other information to set up a path for a full scan.

At decision block 620, the computing device 130 may compare the measured values to the stored nominal measurements and their permitted tolerances. For example, the distance between two prescribed features on side 1 of the workpiece 111 may nominally be 15 millimeters with a tolerance of 0.5 millimeters. Accordingly, the computing device 130 may determine if the measurements of the workpiece 111 are within tolerances specified by the CAD file. Continuing the immediately prior example, if the distance between the two noted features is 15.6 millimeters, then the workpiece 111 is outside of the permitted tolerances. In that case, flow proceeds to block 624. Conversely, if the workpiece 111 is within specified tolerances (e.g., 15.18 millimeters between the two noted features), then flow proceeds to block 628.

At block 624, the workpiece 111 is not within specified tolerances and the computing device 130 may discard the workpiece 111 and/or note the measurement discrepancy. Flow proceeds to block 632.

At block 628, the computing device 130 identifies the workpiece 111 as being within specified tolerances. Flow proceeds to block 632.

At block 632, an operator or other entity may remove the workpiece 111 from the CMM 100. Flow ends at block 632.

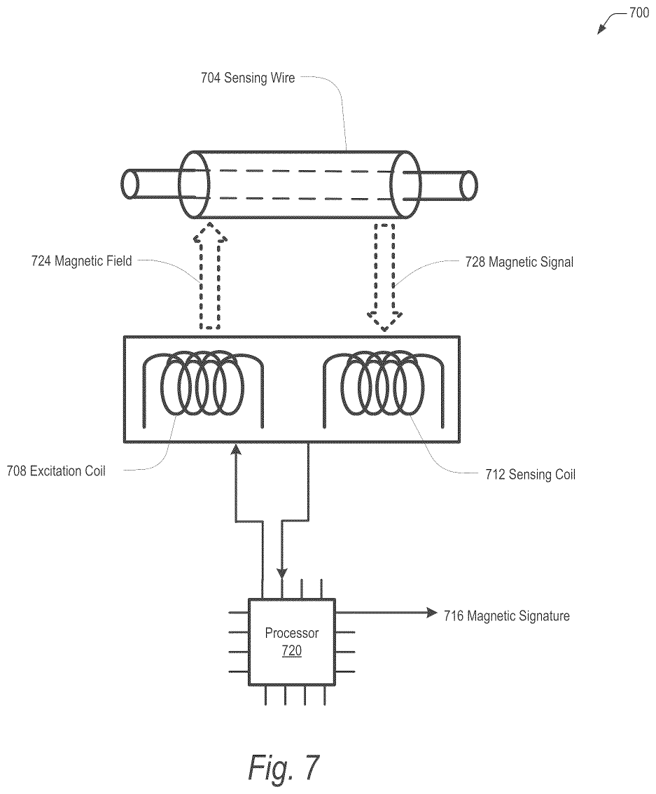

FIG. 7 schematically shows a sensor 700 that may be used in illustrative embodiments, including in the systems described above. Each probe 208 may include an integral or connected sensing wire 704 producing a unique magnetic signature 716. In one embodiment, the sensor 700 may include a piezomagnetic or similar bistable sensing wire 704 or magnetic sensor and a reader. The reader may include a passive portion and an active portion. The passive portion may include a sensing coil 712 that receives a magnetic signal 728 via magnetic induction and the active portion may include an excitation coil 708 that emits a magnetic field 724 to the sensing wire 704. A multi-stylus probe 208 may only require a single sensing wire 704 to uniquely identify the probe 208. The sensing wire 704 may be adjusted for magnetization by a single Barkhausen jump from one end of the sensing wire 704 to the other end of the sensing wire 704. The sensing wire 704 may be made from a metallic alloy core surrounded by a glass coating. The metallic core may have a diameter between approximately 1-50 μm and the glass coating thickness may be between 2-20 μm.

Other embodiments may use other devices in lieu of the bistable sensing wire 704. For example, some embodiments may use a permanent magnet, magnetostrictive materials (e.g., using Terfenol-D or Galfenol), other piezomagnetic materials that change their magnetic properties (e.g., magnetization or permeability) when subjected to mechanical stress, magnetic markers, encoded tags, inductive devices with permanent magnets.

In the embodiment shown, the excitation coil 708 and the bistable sensing wire 704 are placed proximate to each other, preferably in a mutual position with an asymmetric magnetic field with respect to the sensing wire 704. For example, depending on the specific sensor chosen, a proximity of between 50-100 mm may be required for reliable detection. Unless present in noisy magnetic or electric fields, the excitation coil 708 may be powered with only a few milliamps. Output from the sensing coil 712 may include magnetic and electrical noise present in the vicinity of the sensing coil 712 during measurement. A processor 720 may filter noise from the received signal and amplify the signal, if needed.

In one embodiment, the processor 720 or another circuit may provide an AC waveform, such as a triangular waveform, to the excitation coil 708. The sensing wire 704 is within the proximity of the excitation coil 708 such that the sensing wire 704 reacts according to the magnetic field 724 produced by the excitation coil 708. This magnetic field 724 corresponds to the AC waveform. The sensing coil 712 responsively detects the reaction of the sensing wire 704 and provides a magnetic signal 728 to the processor 720. The processor 720 may then digitize the signal as well as filter/amplify the signal. Based on the relationship between the AC waveform and the received signal 728, the processor 720 may determine a unique ID associated with the sensing wire 704, and hence the corresponding probe 208.

In another embodiment, the processor 720 may provide a number of magnetic signatures 716 to further logic or circuitry coupled to a memory device that stores magnetic signatures 716 for multiple probes 208. In one embodiment, the coils 708, 712 and possibly the processor 720 may be located where a power source may be available, such as a probe rack port or within CMM robotics 104.

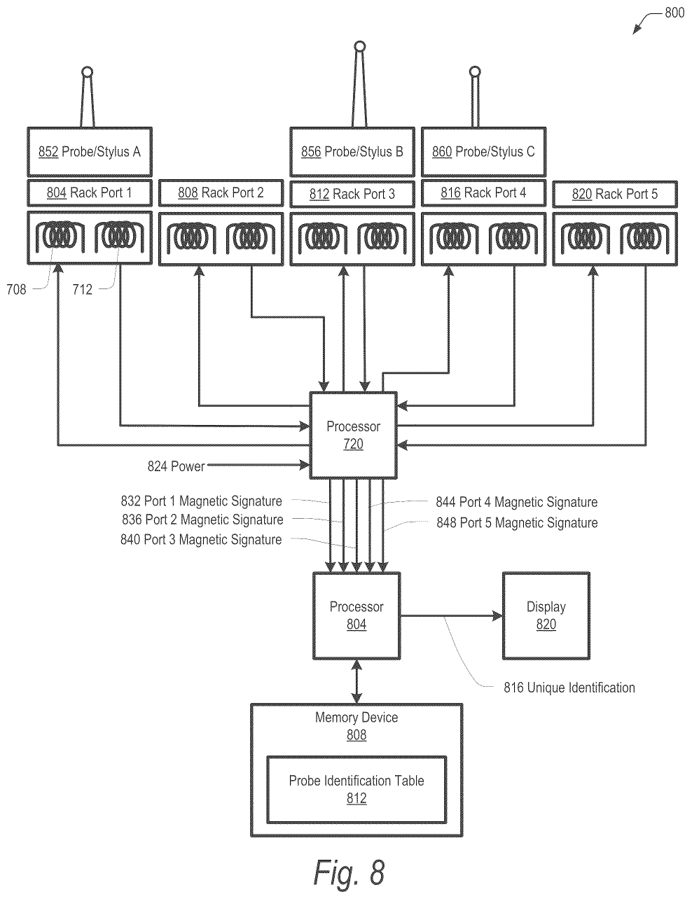

FIG. 8 shows an exemplary probe identification system 800 using probe rack ports in accordance with illustrative embodiments. As known in the art, a CMM 100 may include and/or use a number of probe racks 204 to store a variety of different types and sizes of probes 208. For example, different sizes, orientation, and configurations of probes 208 may be stored in rack ports, including contact probes, non-contact optical probes, or non-contact camera probes.

FIG. 8 illustrates a probe rack system 800 that includes five rack ports, identified as rack port 1 804, rack port 2 808, rack port 3 812, rack port 4 816, and rack port 5 820. Rack port 1 804 is occupied by probe/stylus A 852, rack port 3 812 is occupied by probe/stylus B 856, and rack port 4 816 is occupied by probe/stylus C 860. Probe rack port 2 808 and probe rack port 5 820 are currently unoccupied by probes 208. Each of the probes/stylus' 852, 856, and 860 includes a passive portion of a magnetic sensor (e.g., a sensing wire 704). In the illustrated embodiment, the probe rack 204, 404 includes the reader, which includes an excitation coil 708 and a sensing coil 712 for each rack port. In another embodiment, the reader may be a standalone structure separate from the probe rack 204, 404. For example, a separate reader may not have rack ports per se, but instead have a single excitation coil 708 and a single sensing coil 712. A robotic arm 104 or other movable member may move a captured probe 208 within sensing proximity of the separate reader for the system 100 to uniquely identify the captured probe 208.

In the illustrated embodiment, associated with each rack port is a reader that includes a pair of coils: an excitation coil 708 and a sensing coil 712, as shown in FIG. 7. When docked within a rack port, probes 208 are within a sensing distance (sensing proximity) of the coils 708, 712. Prior to being docked in a rack port, the robotic arm 104 may move a captured probe 208 into sensing proximity of an empty rack port (or a separate reader, as described previously) in order for the probe rack system 800 to reliably detect and identify the captured probe 800. Therefore, preferably the reliable proximity or sensing distance from the coils 708, 712 to a captured probe 208 (by the robotic arm 104) is greater than the docked probe distance (e.g., the distance between docked probe/stylus A 852 and coils 708, 712). Each input and output to/from the coils 708, 712 is provided to the processor 720. As stated with respect to FIG. 7, the processor 720 may generate AC waveforms to the excitation coils 708 and filter noise and digitize inputs from the sensing coils 712.

In one embodiment (not shown), the same processor 720 may interface with the coils 708, 712 as well as one or more memory devices, communication devices, and/or display devices. In the illustrated embodiment, the processor 720 may provide the digitized magnetic signatures corresponding to each rack port to another processor 804 that interfaces with a memory device 808 and a display 820 (and possibly a communication device to transmit unique identifications 816 to the CMM 100 or other entity). A magnetic signature 832 for port 1, a magnetic signature 836 for port 2, a magnetic signature 840 for port 3, a magnetic signature 844 for port 4, and a magnetic signature 848 for port 5 may be provided to processor 804. The port 1 magnetic signature 832 would correspond to probe/stylus A 852, the port 3 magnetic signature 840 would correspond to probe/stylus B 856, and the port 4 magnetic signature 844 would correspond to probe/stylus C 860. The port 2 magnetic signature 836 and the port 5 magnetic signature 848 would reflect no probe/stylii installed in either ports 808 or 820.

In response to the processor 720 generating magnetic signatures or changes to magnetic signatures, the processor 804 may read a probe identification table 812 stored in an accessible memory device 808 to determine a unique identification 816 and transmit the unique identification 816 to a display 820 or a communication device. The unique identification 816 may include an association between a rack port and a probe 208 or a probe/stylus, such as probe/stylus A 852, probe/stylus B 856, or probe/stylus C 860.

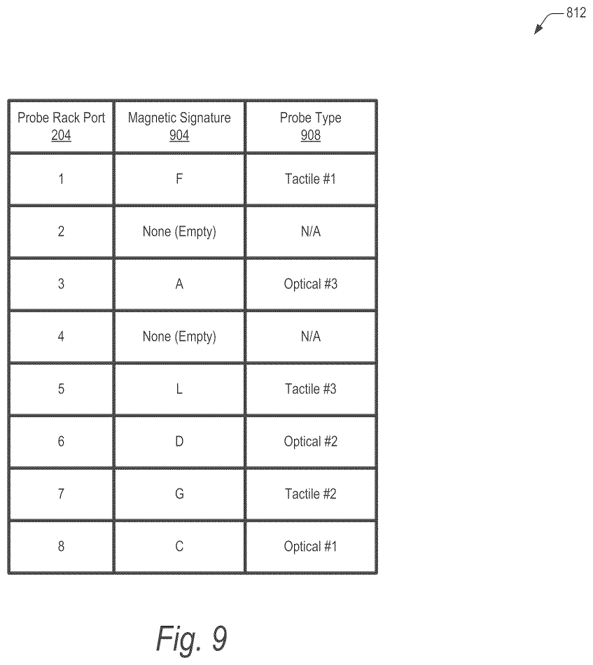

FIG. 9 shows a sample probe identification table 812. In one embodiment, one or more processors 720 associated with the probe rack 204 or another processor 804 may store data related to probe 208 identities in the probe identification table 812 in an accessible memory device 808. In one embodiment, the memory device 808 may be associated with the one or more processors 720, 804 and/or the probe rack 204. In another embodiment, the memory device 808 may be associated with the computing device 130. In another embodiment, the memory device 808 may be associated with a standalone reader.

The probe identification table 812 associates a specific probe 208 with a probe rack port or rack slot. In the illustrated example, the rack includes eight probe rack ports 204, identified as port 1 through port 8. Six of the eight rack ports (ports 1, 3, and 5-8) are occupied by probes 208 while two rack ports (2 and 4) are empty. Sensors 704 in each probe 208 have a corresponding magnetic signature 904, as discussed previously. The probe 208 in rack port 1 has a magnetic signature 904 ‘F’, the probe 208 in rack port 3 has a magnetic signature 904 ‘A’, the probe 208 in rack port 5 has a magnetic signature 904 ‘L’, the probe 208 in rack port 6 has a magnetic signature 904 ‘D’, the probe 208 in rack port 7 has a magnetic signature 904 ‘G’, and the probe 208 in rack port 8 has a magnetic signature 904 ‘C.’. Because there are no probes 208 in rack ports 2 and 4, there may not be a magnetic signature 904, or there is a specific magnetic signature 904 that corresponds to no probe 208 installed in a rack port.

The table 812 may also include a probe type 908 for each detected probe 208. For example, probes 1, 5, and 7 may be tactile (i.e., contact) probes while probes 3, 6, and 8 may be optical (i.e., contactless) probes. Tactile probes may include probe “Tactile 1” in rack port 1, “Tactile 2” in rack port 7, and “Tactile 3” in rack port 5. Optical probes may include probe “Optical 1 in rack port 8, “Optical 2” in rack port 6, and “Optical 3” in rack port 3.

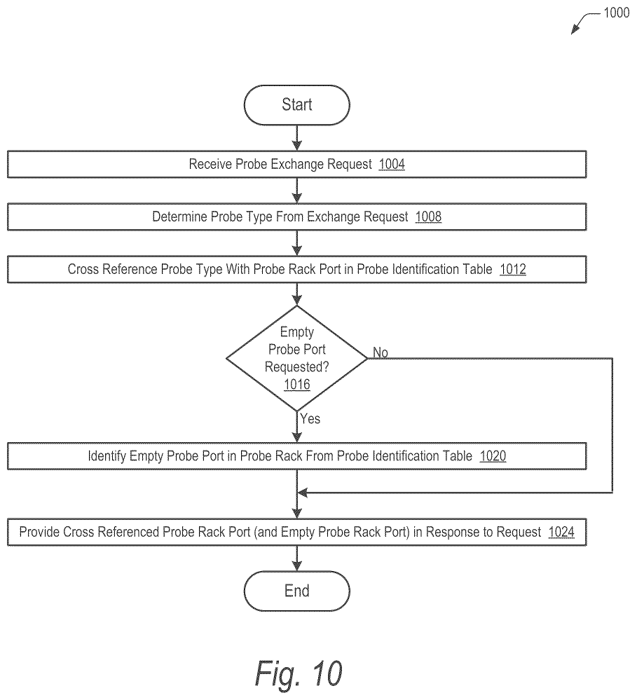

FIG. 10 shows a probe exchange process 1000 in accordance with illustrative embodiments. The probe exchange process 1000 provides information to an operator or a robotic arm 104 that allows a current probe 208 that is no longer being used to be stored to an empty probe port of a probe rack 204 while identifying a probe port containing a desired probe 208. It should be noted that some of the steps may be performed in a different order than that shown, or at the same time. Those skilled in the art therefore can modify the process as appropriate.

The process begins at block 1004, in which an exchange request is received. In one embodiment, the exchange request may be received by the computing device 130. In another embodiment, the exchange request may be received by the processor 720 associated with a probe rack 204, 404 or another processor 804. The exchange request may specify a specific probe 208 that needs to be used by the CMM 100 after the probe exchange.

Specifically, as noted at block 1008, the processor 720, 804 or computing device 130 may determine a desired probe type 908. For example, continuing the example from before, an “Optical #2” probe type 908 may be requested in the exchange request. Flow proceeds to block 1012.

At block 1012, the processor 720, 804 or computing device 130 accesses the probe identification table 812 to determine the location of the desired probe 908 in the probe rack 204. From the previous example, for a received probe type 908 of “Optical #2”, the corresponding probe rack port is port 6. Flow proceeds to block 1016.

At decision block 1016, the processor 720, 804 or computing device 130 may determine if the exchange request includes an empty probe port. For example, the exchange request may include an empty probe port if a probe 208 is being returned to the probe rack 204. If the exchange request includes a request for an empty probe port (i.e., a request to store the probe 208 it then is carrying), then flow proceeds to block 1020. To that end, the processor 720, 804 or computing device 130 may identify the empty probe port in the probe rack 204 from the probe identification table 812. When positioning the probe 208 in the empty port, a reader or other device (e.g., coils 708, 712, processor 720, processor 804, memory device 808, and probe identification table 812) determines the identity of the returned probe 208 and update the probe identification table 812 accordingly. For example, the returned probe 208 may be stored in port 2 (i.e., an empty port in FIG. 8). In that case, the table 812 may be updated with information about that returned probe 208, indication that such probe 208 is in its new location (e.g., camera #1 probe now stored in rack port 2).

To identify the returned probe 208, illustrative embodiments may use the magnetic reading device described herein to determine the magnetic signature 904 of the returned probe 208. In other words, the reading device (e.g., FIGS. 7 and 8) reads the passive magnetic sensor 704 associated or mounted on or within the probe 208, and records that signature 904 for future use.

Accordingly, there is no need to reserve ports for the probes 208 or require specific probes 208 or probe types to be stores in specific rack slots. Instead, they are assigned to any of the open ports and their presence in those ports may be recorded in the probe identification table 812.

If the exchange request does not include a request for an empty probe port (i.e., a request to return a probe 208 back to the rack 204), then the process continues to block 1024. In this case, perhaps the CMM 100 does not require a probe 208 change at this time (e.g., it may not have a probe 208 already attached to robotic arm 104). Specifically, at this point in the process, the processor 720, 804 or computing device 130 may simply access the table 812, identify the port holding the desired probe 208, and communicate the robotic arm 104 to move to the port holding the desired probe 208. The CMM 100 then may secure the probe 208 to the CMM 100, ending the process.

In another embodiment, the probe identification table 812 may not have a column recording the specific port holding the desired probe 208. In that case, the table 812 may just show the magnetic signature 904 of all the probes 208 in the rack 204. The reading device therefore may read the magnetic signatures 904 of each probe 208 until it detects that of the desired probe 208. The CMM 100 then may secure the desired probe 208 after detection.

Illustrative embodiments discuss a specific magnetic sensor (e.g., that shown in FIG. 7). Illustrative embodiments may apply to other magnetic sensors, such as simple magnets or magnetic security tags. Accordingly, discussion of a specific magnetic sensor is illustrative and not intended to limit various other embodiments.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, solid state drive, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink rapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

Various embodiments of the invention have been described in fulfillment of the various objectives of the invention. It should be recognized that these embodiments are merely illustrative of the principles of the present invention. Numerous modifications and adaptions thereof will be readily apparent to those skilled in the art without departing from the spirit and scope of the present invention as defined in the following claims.

What is claimed is:

1. A measurement probe identification system for a coordinate measurement machine, the system, comprising:
a measurement probe configured to measure a workpiece on a coordinate measurement machine, the measurement probe being one of a tactile measurement probe, a non-contact light based probe, and a camera probe; and
a magnetic sensor associated with the measurement probe, the measurement probe having a unique identification, the magnetic sensor configured to emit a magnetic signal in response to receipt of a magnetic field,
the magnetic signal associated with a unique identification of the measurement probe based on a magnetic signature,
the magnetic signature being readable to determine the unique identification.

2. The measurement probe identification system of claim 1, further comprising a reader that receives the magnetic signal and converts the magnetic signal into the magnetic signature, the reader configured to determine the unique identification of the measurement probe as a function of the magnetic signature.

3. The measurement probe identification system of claim 1, wherein the reader comprises a coil to detect the magnetic signature.

4. The measurement probe identification system of claim 2, wherein the reader is configured to determine the unique identification in response to the magnetic sensor being proximate to the coil.

5. The measurement probe identification system of claim 2, wherein the reader comprises:
a passive portion configured to receive the magnetic signal; and
an active portion configured to emit the magnetic field toward the magnetic sensor.

6. The measurement probe identification system of claim 4, wherein the active portion uses magnetic induction to produce the magnetic signal received by the passive portion.

7. The measurement probe identification system of claim 1, comprising:
a probe rack, configured to temporarily store one or more different measurement probes in rack ports, wherein the probe rack comprises the reader.

8. The measurement probe identification system of claim 7, further comprising:
a memory device, configured to store unique identifications for measurement probes stored in rack ports.

9. The measurement probe identification system of claim 8, further comprising:
a processor, coupled to the memory device, configured to update the unique identifications in the memory device in response to measurement probes added to or removed from the rack ports.

10. A method of selecting a measurement probe of a coordinate measurement machine, the method comprising:
providing a measurement probe configured to be used with a coordinate measurement machine, the measurement probe having an associated magnetic sensor, the magnetic sensor having an associated unique identification;
emitting a magnetic field toward the measurement probe to cause the magnetic sensor to produce a magnetic signal in response to receipt of the magnetic field;
converting the magnetic signal into a magnetic signature; and
determining, by a reader, the unique identification of the measurement probe as a function of the magnetic signature.

11. The method of claim 10, wherein the reader comprises a coil to detect the magnetic signal.

12. The method of claim 11, wherein determining, by the reader, comprises:
determining the unique identification in response to the magnetic sensor being proximate to the coil.

13. The method of claim 10, wherein the reader comprises:
a passive portion configured to receive the magnetic signal; and
an active portion configured to emit the magnetic field toward the magnetic sensor.

14. The method of claim 13, wherein the active portion uses magnetic induction to produce the magnetic signal received by the passive portion.

15. The method of claim 10, wherein a probe rack having rack ports is configured to store one or more different measurement probes in the rack ports, wherein the probe rack comprises the reader.

16. The method of claim 15, wherein the unique identification is associated with a specific rack port.

17. The method of claim 16, further comprising:
storing in memory unique identifications for measurement probes stored in rack ports.

18. The method of claim 17, further comprising:
adding a measurement probe to the rack port or removing a measurement probe from one of the rack ports; and
updating the unique identifications in memory in response to measurement probes in added to or removed from the rack ports.

19. A computer program product for use on a computer system for selecting a measurement probe of a coordinate measurement machine, the computer program product comprising a tangible, non-transient computer usable medium having computer readable program code thereon, the computer readable program code comprising:
program code for directing emission of a magnetic field toward the measurement probe to cause the measurement probe to produce a magnetic signal;
program code for controlling a reader to read the magnetic signal and convert the magnetic signal into a magnetic signature;
program code for determining a unique identification of a measurement probe as a function of the magnetic signature; and
program code for selecting the measurement probe as a function of the determined unique identification.

20. The computer program product of claim 19, wherein the program code determines the unique identification in response to a passive coil is proximate to a magnetic sensor of the measurement probe, wherein the measurement probe comprises the magnetic sensor and the reader comprises the passive coil and an active coil configured to emit the magnetic field.
